(19) United States
(12) Patent Application Publication
(10) Pub. No.: US 2023/0252602 A1
(43) Pub. Date: Aug. 10, 2023

(54) METHOD AND ELECTRONIC DEVICE FOR EFFICIENTLY REDUCING DIMENSIONS OF IMAGE FRAME

(71) Applicant: SAMSUNG ELECTRONICS CO, LTD., Suwon-si (KR)

(72) Inventors: Tejpratap Venkata Subbu Lakshmi GOLLANAPALLI, Bengaluru Karnataka (IN); Raja KUMAR, Bengaluru Karnataka (IN); Dewashish DHARKAR, Bengaluru Karnataka (IN)

(21) Appl. No.: 17/978,458

(22) Filed: Nov. 1, 2022

Related U.S. Application Data
(63) Continuation of application No. PCT/KR2022/015277, filed on Oct. 11, 2022.

(30) Foreign Application Priority Data
Feb. 7, 2022 (IN) 202241006331

(51) Int. Cl. G06T 3/40

(52) U.S. Cl. CPC G06T 3/4046

(57) ABSTRACT

Embodiments of the disclosure provide a method and device for efficiently reducing dimensions of an image frame by an electronic device. The method includes: receiving the image frame; transforming the image frame from a spatial domain comprising a first plurality of channels to a non-spatial domain comprising a second plurality of channels, where a number of the second plurality of channels is greater than a number of the first plurality of channels; removing channels comprising irrelevant information from among the second plurality of channels using an AI engine to generate a low-resolution image frame in the non-spatial domain; and providing the low-resolution image frame to a neural network for a faster and accurate inference of the image frame.

### CROSS-REFERENCE TO RELATED APPLICATIONS

This application is a bypass continuation application of International Application No. PCT/KR2022/015277 designating the United States, filed on Oct. 11, 2022, in the Korean Intellectual Property Receiving Office and claiming priority to Indian Patent Application No. IN202241006331, filed Feb. 7, 2022, in the Indian Intellectual Property Office, the disclosures of which are incorporated by reference herein in their entireties.

### BACKGROUND

### 1. Field

The present disclosure relates to an electronic device, and more specifically to a method and the electronic device for efficiently reducing dimensions of an image frame.

### 2. Description of Related Art

A flagship computing device usually uses an image with higher resolution (e.g. 1600×1600) to achieve better accuracy for performing Artificial Intelligence (AI) based use cases such as segmentation, matting, night-mode, depth estimation, deblurring, live focus for photo, etc. It is difficult to realize performing the AI based use cases using the image with higher resolution on a mid-tier/low-end computing device due to high memory and computational requirements. FIG. 1 is a diagram illustrating example scenarios of performing an AI based use case, according to prior art. As shown, the flagship computing device 10 generates a segmented output (13) from a high-resolution image with dimension 1600×1600×4 (11) by performing the segmentation using a Deep Neural Network (DNN) (12). 1600, 1600, 4 represent height, width, and a number of channels of the high-resolution image in spatial domain respectively. An inference time for generating the segmented output (13) is 103 milliseconds (ms). The segmented output (13) meets desired Key Performance Indicators (KPI) and has good accuracy. As shown, the mid-tier/low-end computing device 20 generates a segmented output (14) from the high-resolution image with dimension 1600×1600×4 (11) by performing the segmentation using the DNN (12). The inference time for generating the segmented output (13) is 261 ms, which more than the inference time taken by the flagship computing device. The segmented output (13) does not meet the desired KPI, but has good accuracy.

Existing method allows the mid-tier/low-end computing device to down sample the high-resolution image to half or quarter of the image's actual resolution for enabling the AI based use cases on the mid-tier/low-end computing device and achieving the desired KPI. Even though the down sampling operation reduces computation, higher memory requirement, and communication bandwidth, the down sampling operation causes to removal of salient information from the down sampled image as compared to the high-resolution image, which results in loss of accuracy.

As shown, the mid-tier/low-end computing device 30 converts the high-resolution image with dimension 1600×1600×4 (11) to a low-resolution image with dimension 800×800×4 (15), which results in loss of significant features in the high-resolution image with dimension 1600×1600×4 (11). 800, 800, 4 represent height, width, and number of channels of the low-resolution image in the spatial domain respectively. Further, the mid-tier/low-end computing device generates a segmented output (16) from the low-resolution image with dimension 800×800×4 (11) by performing the segmentation using the DNN (12). The inference time for generating the segmented output (13) is 90 ms, which is near to the inference time taken by the flagship computing device. The segmented output (13) meets the desired KPI, but has poor accuracy. Since reducing the resolution results in poor accuracy, it is hard to enable the AI based use case on the mid-tier/low-end computing device.

The existing method allows the mid-tier/low-end computing device to reduce complexity of the neural network (e.g. DNN) used for processing the high-resolution image for AI based use cases. Few existing layers of the neural network remove from the neural network for reducing the complexity of the neural network, which also results in accuracy degradation and hence poor use case performance as compared to results of the flagship computing devices. Thus, it is desired to provide a useful solution for processing the image for the AI based use cases by keeping the desired KPI and an acceptable amount of accuracy.

### SUMMARY

Embodiments of the disclosure may provide a method and an electronic device for efficiently reducing dimensions of an image frame for AI based use cases within a lower inference time and keeping desired accuracy and KPI.

Embodiments of the disclosure may transform the image frame in Red Green Blue (RGB)/spatial domain to a low-resolution image in non-spatial domain and thereby filtering out irrelevant/less-informative channels of the image frame in the non-spatial domain, which results in dimensionality reduction of the image frame and thereby reducing computations and memory requirements for the AI based use cases.

Embodiments of the disclosure may select most informative channels in the channels of the image frame in the non-spatial domain and ignore the rest of channels of the image frame in the non-spatial domain Thus, the electronic device can perform faster execution of the AI based use cases by achieving better accuracy as compared to existing methods, as the electronic device operates on the high-resolution image without increasing processing time or network complexity.

Embodiments of the disclosure may provide a generic stub layer as a simple plug and play block to embed with a neural network by bypassing insignificant input layers of the neural network for compatibility of the neural network to process the transformed image frame in the non-spatial domain without changing/retraining/redesigning an existing architecture of the neural network.

Accordingly, various example embodiments of the disclosure provide a method for efficiently reducing dimensions of an image frame by an electronic device. The method includes: receiving, by the electronic device, the image frame; transforming, by the electronic device, the image frame from a spatial domain comprising a first plurality of channels to a non-spatial domain comprising a second plurality of channels, wherein a number of the second plurality of channels is greater than a number of first plurality of channels; removing, by the electronic device, channels comprising irrelevant information from among the second plurality of channels using an Artificial Intelligence (AI) engine to generate a low-resolution image frame in the non-spatial domain; and providing, by the electronic device, the low-resolution image frame to a neural network for a faster and accurate inference of the image frame.

In an example embodiment, a Discrete Cosine Transformation (DCT) or a Fourier transformation on the image frame may be performed by the electronic device for transforming the image frame from the spatial domain to the non-spatial domain

In an example embodiment, a generic stub layer may be embedded at an input of the neural network for compatibility of the neural network in receiving the low-resolution image frame, where the generic stub layer bypasses input layers of the neural network that are relevant only for the image frame in the spatial domain.

In an example embodiment, the non-spatial domain comprises a Luminance, Red difference, Blue difference (Y, C, B) domain, a Hue, Saturation, Value (H, S, V) domain, and a Luminance, Chrominance (YUV) domain.

In an example embodiment, transforming, by the electronic device, the image frame from the spatial domain comprising the first plurality of channels to the non-spatial domain comprising the second plurality of channels, where the number of the second plurality of channels is greater than the number of first plurality of channels, comprises: transforming, by the electronic device, the image frame from the spatial domain to the non-spatial domain with the first plurality of channels; and grouping, by the electronic device, components of the transformed image frame with a same frequency into a channel of the second plurality of channels by preserving spatial position information of each component.

In an example embodiment, removing, by the electronic device, the channels comprising the irrelevant information from among the second plurality of channels using the AI engine to generate the low-resolution image frame in the non-spatial domain, comprises: generating, by the electronic device, a tensor by performing a depth-wise convolution and average pool on each channel of the second plurality of channels, including, two trainable parameters with each component of the tensor, determining, by the electronic device, values of the two trainable parameters using the AI engine, determining, by the electronic device, a binary value of each component of the tensor based on the values of the two trainable parameters, performing, by the electronic device, an elementwise product between the second plurality of channels and the binary value of the components of the tensor, filtering, by the electronic device, channels without zero value among the second plurality of channels upon performing the elementwise product, and generating, by the electronic device, the low-resolution image frame in the non-spatial domain using the filtered channels.

Accordingly, various example embodiments herein provide an electronic device for efficiently reducing the dimensions of an image frame. The electronic device includes: an image frame inferencing engine comprising executable program instructions, a memory, a processor, where the image frame inferencing engine is coupled to the memory and the processor. The image frame inferencing engine is configured to: receive the image frame; receive the image frame transforming the image frame from the spatial domain comprising the first plurality of channels to the non-spatial domain comprising the second plurality of channels, wherein the number of the second plurality of channels is greater than the number of first plurality of channels; receive the image frame removing the channels comprising irrelevant information from among the second plurality of channels using an artificial intelligence (AI) engine to generate the low-resolution image frame in the non-spatial domain; and receive the image frame providing the low-resolution image frame to the neural network for the faster and accurate inference of the image frame.

These and other aspects of the various example embodiments herein will be better appreciated and understood when considered in conjunction with the following description and the accompanying drawings. It should be understood, however, that the following descriptions, while indicating various example embodiments and numerous specific details thereof, are given by way of illustration and not of limitation. Many changes and modifications may be made within the scope of the disclosure, and the embodiments herein include all such modifications.

### BRIEF DESCRIPTION OF THE DRAWINGS

In the accompanying drawings, like reference letters indicate corresponding parts in the various figures. Further, the above and other aspects, features and advantages of certain embodiments of the present disclosure will be more apparent from the following detailed description, taken in conjunction with the accompanying drawings, in which:

FIG. 1 is a diagram illustrating example scenarios of performing an AI based use case, according to the prior art;

FIG. 2 is a diagram illustrating an example scenario of performing the AI based use case by an electronic device, according to various embodiments;

FIG. 3 is a block diagram illustrating an example configuration of an electronic device for efficiently reducing the dimensions of an image frame, according to various embodiments;

FIG. 4 is a flowchart illustrating an example method for efficiently reducing the dimensions of the image frame, according to various embodiments;

FIGS. 5 and 6 are diagrams illustrating examples of efficiently reducing the dimensions of the image frame, according to various embodiments; and

FIG. 7 is a diagram illustrating an example scenario of embedding a generic stub layer at an input of a neural network, according to various embodiments.

### DETAILED DESCRIPTION

The example embodiments herein and the various features and advantageous details thereof are explained more fully with reference to the non-limiting examples that are illustrated in the accompanying drawings and detailed in the following description. Descriptions of well-known components and processing techniques may be omitted so as to not unnecessarily obscure the description herein. The various example embodiments described herein are not necessarily mutually exclusive, as various embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

Various example embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits of a block may be implemented by dedicated hardware, or by a processor (e.g., one or more programmed microprocessors and associated circuitry), or by a combination of dedicated hardware to perform some functions of the block and a processor to perform other functions of the block. Each block of the various embodiments may be physically separated into two or more interacting and discrete blocks without departing from the scope of the disclosure. Likewise, the blocks of the various embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally used simply to distinguish one element from another.

Throughout this disclosure, the terms “image frame” and “image” are used interchangeably and refer to the same feature.

Accordingly, the various example embodiments herein provide a method for efficiently reducing dimensions of an image frame by an electronic device. The method includes receiving, by the electronic device, the image frame. The method includes transforming, by the electronic device, the image frame from a spatial domain comprising a first plurality of channels to a non-spatial domain comprising a second plurality of channels, wherein a number of the second plurality of channels is greater than a number of first plurality of channels. The method includes removing, by the electronic device, channels comprising irrelevant information from among the second plurality of channels using an Artificial Intelligence (AI) engine to generate a low-resolution image frame in the non-spatial domain. The method includes providing, by the electronic device, the low-resolution image frame to a neural network for a faster and accurate inference of the image frame.

Accordingly, the various example embodiments herein provide the electronic device for efficiently reducing the dimensions of an image frame. The electronic device includes an Image Frame Inferencing Engine (IFIE) including various circuitry and/or executable program instructions, a memory, a processor, where the image frame inferencing engine is coupled to the memory and the processor. The image frame inferencing engine is configured for receiving the image frame. The image frame inferencing engine is configured for receiving the image frame transforming the image frame from the spatial domain comprising the first plurality of channels to the non-spatial domain comprising the second plurality of channels, wherein the number of the second plurality of channels is greater than the number of first plurality of channels. The image frame inferencing engine is configured for receiving the image frame removing the channels comprising irrelevant information from among the second plurality of channels using the AI engine to generate the low-resolution image frame in the non-spatial domain. The image frame inferencing engine is configured for receiving the image frame providing the low-resolution image frame to the neural network for the faster and accurate inference of the image frame.

Unlike existing methods and systems, the electronic device may efficiently reduce dimensions of the image frame for AI based use cases within a lower inference time and keeps desired accuracy and KPI.

Unlike existing methods and systems, the electronic device may transform the image frame in Red Green Blue (RGB)/spatial domain to a low-resolution image in the non-spatial domain and thereby filtering out irrelevant/less-informative channels of the image frame in the non-spatial domain, which results in dimensionality reduction of the image frame and thereby reducing computations and memory requirements for the AI based use cases.

Unlike existing methods and systems, the electronic device may select most informative channels in the channels of the image frame in the non-spatial domain and ignores the rest. Thus, the electronic device can perform faster execution of the AI based use cases by achieving better accuracy as compared to conventional systems, as the electronic device operates on the high-resolution image without increasing processing time or network complexity.

Unlike existing method and systems, the electronic device may use a generic stub layer as a simple plug and play block to embed with the neural network by bypassing insignificant input layers of the neural network for compatibility of the neural network to process the transformed image frame in the non-spatial domain without changing/retraining/redesigning an existing architecture of the neural network.

Unlike existing method and systems, the electronic device may transform the image frame in the spatial domain to the low-resolution image frame in the non-spatial domain using Discrete Cosine Transform (DCT) which changes the dimensions of the image frame in the spatial domain The dimensionality of the image frame in the non-spatial domain for the network in Height (H) and Width (W) is drastically reduced by a factor of ‘X’. The shape of the image frame in the non-spatial domain input in which the channels or depth is increased by a factor of 2x is hardware accelerator (e.g., DSP/NPU) friendly format and hence is very computed effective.

The electronic device may identify irrelevant features/channels in the low-resolution image frame using a novel deep learning engine (e.g., AI engine) thereby reducing the dimension of the transformed image frame and hence drastically reducing computation and memory requirements, and data transfer bandwidth. Since preserving the relevant information in the transformed image frame, the disclosed method enables to achieve better accuracy as compared to the image frame in the spatial domain. Thus, the disclosed method facilitates to enable flagship compatible AI based use cases having high input resolution on low-end/mid-tier computing devices with better accuracy and less computations/memory requirement. Additionally, since an input image is transformed to the non-spatial domain, the electronic device can easily operate on high-resolution images as compared to spatial domain methods. The disclosure results in accuracy improvements in flagship computing devices, accuracy and performance, and power saving benefits in the case of the low-end/mid-tier computing devices.

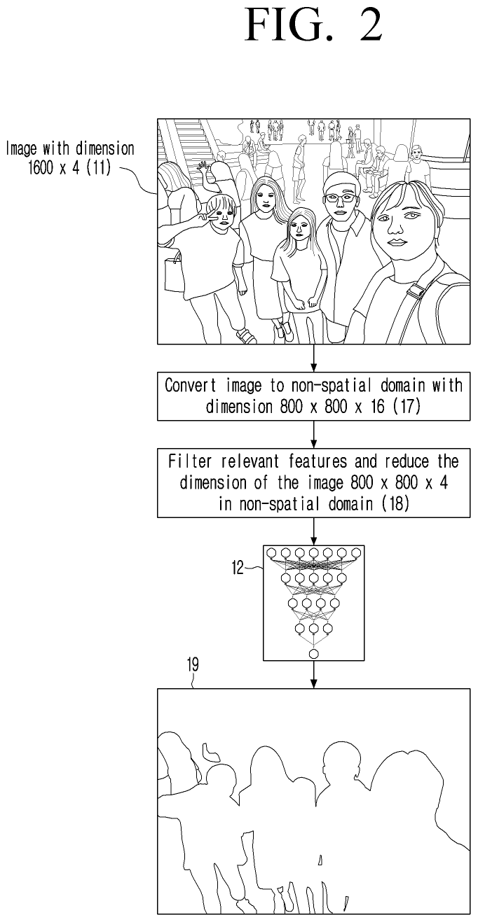

Referring now to the drawings, and more particularly to FIGS. 2 through 7, there are shown various example embodiments.

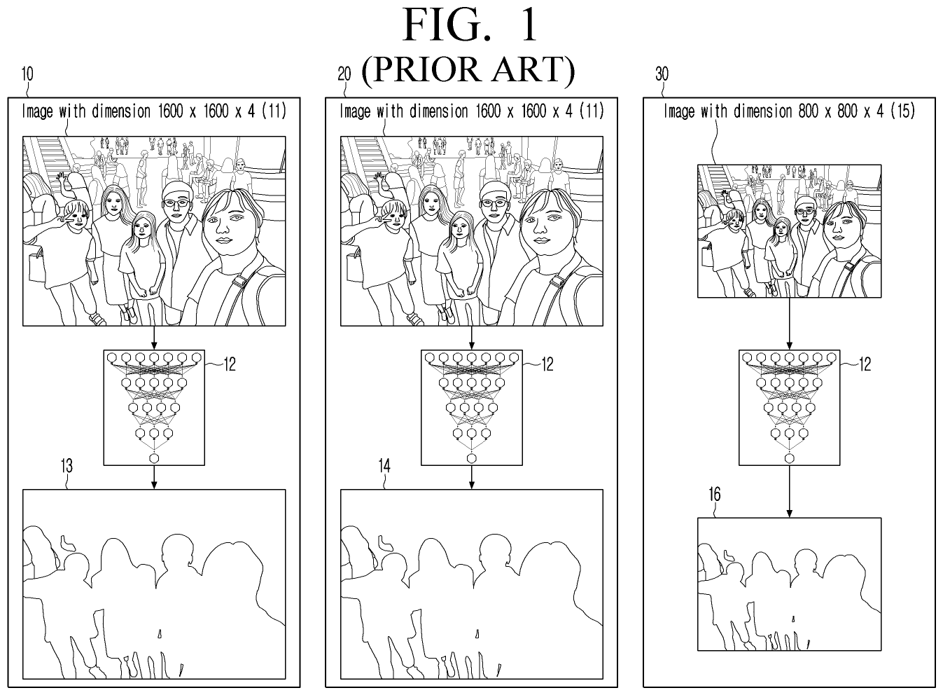

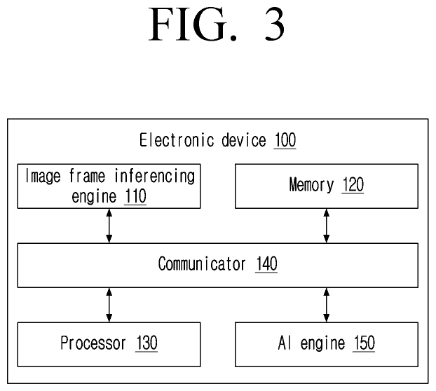

FIG. 2 is a diagram illustrating an example scenario of performing an AI based use case by an electronic device (100, refer to FIG. 3), according to various embodiments. At 17, unlike to scenarios described in FIG. 1, the disclosed electronic device (100) converts a high-resolution image with dimension 1600×1600×4 (11) in a spatial domain to a non-spatial domain. 1600, 1600, 4 represent height, width, and number of channels of the high-resolution image respectively. Further, the electronic device (100) converts the image in the non-spatial domain with dimension 1600×1600×4 to a low-resolution image with dimension 800×800×16. 800, 800, 16 represent the height, width, and number of channels of the low-resolution image in the non-spatial domain respectively. Due to reducing the size (e.g., height and width) of the high-resolution image in the non-spatial domain and increasing the number of channels, the salient features of the high-resolution image will be preserved. At 18, the electronic device (100) filters relevant features from the low-resolution image with dimension 800×800×16 (17) and reduces the dimension of the image to 800×800×4 in the non-spatial domain. Thus, the electronic device (100) reduces the dimensionality of the high-resolution image without losing the relevant features. The image with dimensionality 800×800×4 can be easily handled by even a mid-tier/low-end computing device for performing the AI based use case without creating computational or memory overheads. For example, the electronic device (100) can generate a segmented output (19) from the low-resolution image with dimension 800×800×4 in the non-spatial domain by performing segmentation using the DNN (12) within a faster inference time of around 100 ms, and by meeting desired KPI and accuracy.

FIG. 3 is a block diagram illustrating an example configuration of the electronic device (100) for efficiently reducing the dimensions of the image frame, according to various embodiments. Examples of the electronic device (100) include, but are not limited to a smartphone, a tablet computer, a Personal Digital Assistance (PDA), a desktop computer, an Internet of Things (IoT), a wearable device, etc. In an embodiment, the electronic device (100) includes an Image Frame Inferencing Engine (IFIE) (e.g., including various circuitry and/or executable program instructions) (110), a memory (120), a processor (e.g., including processing circuitry) (130), a communicator (e.g., including communication circuitry) (140), and an Artificial Intelligence (AI) engine (150). In an embodiment, the electronic device (100) may additionally include a camera sensor, and a neural network. The IFIE (110) is implemented by processing circuitry such as logic gates, integrated circuits, microprocessors, microcontrollers, memory circuits, passive electronic components, active electronic components, optical components, hardwired circuits, or the like, and may optionally be driven by a firmware. The circuits may, for example, be embodied in one or more semiconductor chips, or on substrate supports such as printed circuit boards and the like.

The IFIE (110) receives the image frame from a source such as the memory (120) or a device connected to the electronic device (100) or the camera sensor of the electronic device (100), where the image frame is created in a spatial domain including a first plurality of channels. Further, the IFIE (110) transforms the image frame from the spatial domain to a non-spatial domain including a second plurality of channels, where a number of the second plurality of channels is more than a number of the first plurality of channels. In an example, the IFIE (110) may perform a Discrete Cosine Transformation (DCT) or a Fourier transformation on the image frame for transforming the image frame from the spatial domain to the non-spatial domain. In an embodiment, the non-spatial domain can be a Luminance, Red difference, Blue difference (Y, C, B) domain, or a Hue, Saturation, Value (H, S, V) domain, or a Luminance, Chrominance (YUV) domain. In an embodiment, for transforming the image frame from the spatial domain to the non-spatial domain, the IFIE (110) transforms the image frame from the spatial domain to the non-spatial domain with the first plurality of channels. Further, the IFIE (110) groups components of the transformed image frame with the same frequency into a channel of the second plurality of channels by preserving spatial position information of each component.

The IFIE (110) removes channels including irrelevant information from among the second plurality of channels using the Artificial Intelligence (AI) engine (150) to generate a low-resolution image frame in the non-spatial domain. In an embodiment, for removing the channels including the irrelevant information from among the second plurality of channels, the IFIE (110) generates a tensor by performing a depth-wise convolution and average pool on each channel of the second plurality of channels. Further, the IFIE (110) adds two trainable parameters with each component of the tensor. Further, the IFIE (110) determines values of the two trainable parameters using the AI engine (150). Further, the IFIE (110) determines a binary value of each component of the tensor based on the values of the two trainable parameters. Further, the IFIE (110) performs an elementwise product between the second plurality of channels and the binary value of the components of the tensor. Further, the IFIE (110) filters the channels without zero value among the second plurality of channels upon performing the elementwise product. Further, the IFIE (110) generates the low-resolution image frame in the non-spatial domain using the filtered channel.

The IFIE (110) provides the low-resolution image frame to the neural network (e.g. Deep Neural Network (DNN)) of the electronic device (100) for a faster and accurate inference of the image frame. In an embodiment, a generic stub layer is embedded at an input of the neural network for compatibility of the neural network in receiving the low-resolution image frame, where the generic stub layer bypasses input layers of the neural network that are relevant only for the image frame in the spatial domain

The memory (120) stores the image frame, the neural network, and an AI model. The memory (120) stores instructions to be executed by the processor (130). The memory (120) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (120) may, in some examples, be considered a non-transitory storage medium. The term “non-transitory” may indicate that the storage medium is not embodied in a carrier wave or a propagated signal. However, the term “non-transitory” should not be interpreted that the memory (120) is non-movable. In some examples, the memory (120) can be configured to store larger amounts of information than its storage space. In certain examples, a non-transitory storage medium may store data that can, over time, change (e.g., in Random Access Memory (RAM) or cache). The memory (120) can be an internal storage unit or it can be an external storage unit of the electronic device (100), a cloud storage, or any other type of external storage.

The processor (130) may include various processing circuitry and may be configured to execute instructions stored in the memory (120). The processor (130) may include one or a plurality of processors. The processor (130) may be a general-purpose processor, such as a Central Processing Unit (CPU), an Application Processor (AP), or the like, a graphics-only processing unit such as a Graphics Processing Unit (GPU), a Visual Processing Unit (VPU) and the like. The processor (130) may include multiple cores to execute the instructions. The communicator (140) may include various communication circuitry and may be configured for communicating internally between hardware components in the electronic device (100). Further, the communicator (140) is configured to facilitate the communication between the electronic device (100) and other devices via one or more networks (e.g. Radio technology). The communicator (140) includes an electronic circuit specific to a standard that enables wired or wireless communication.

At least one of a plurality of modules may be implemented through the AI engine (150). A function associated with AI engine (150) may be performed through the non-volatile memory, the volatile memory, and the processor. The one or a plurality of processors control the processing of the input data in accordance with a predefined operating rule or the AI engine (150) stored in the non-volatile memory and the volatile memory. The predefined operating rule or the AI engine (150) is provided through training or learning. Here, being provided through learning may refer, for example, to, by applying a learning method to a plurality of learning data, the predefined (e.g., specified) operating rule or the AI engine (150) of a desired characteristic being made. The learning may be performed in the electronic device (100) itself in which the AI engine (150) according to an embodiment is performed, and/o may be implemented through a separate server/system. The AI engine (150) may include a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. The learning method is a method for training a predetermined target device (for example, a robot) using a plurality of learning data to cause, allow, or control the target device to make a determination or prediction. Examples of the learning method include, but are not limited to, supervised learning, unsupervised learning, semi-supervised learning, or reinforcement learning.

Although FIG. 3 shows the hardware components of the electronic device (100) it is to be understood that other embodiments are not limited thereon. In various embodiments, the electronic device (100) may include less or a greater number of components. Further, the labels or names of the components are used only for illustrative purpose and does not limit the scope of the disclosure. One or more components can be combined together to perform same or substantially similar function for efficiently reducing the dimensions of the image frame.

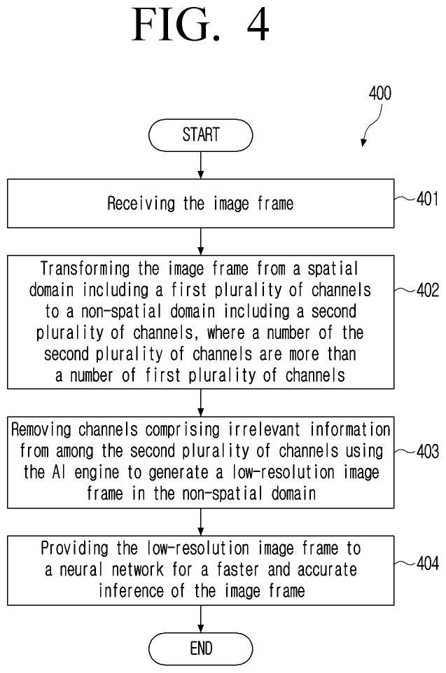

FIG. 4 is a flowchart (400) illustrating an example method for efficiently reducing the dimensions of the image frame, according to various embodiments. In an embodiment, the method allows the IFIE (110) to perform operations 401-404 of the flow diagram (400). At 401, the method includes receiving the image frame. At 402, the method includes transforming the image frame from the spatial domain including the first plurality of channels to the non-spatial domain including the second plurality of channels, where the number of the second plurality of channels is more than the number of the first plurality of channels. At 403, the method includes removing the channels including the irrelevant information from among the second plurality of channels using the AI engine (150) to generate the low-resolution image frame in the non-spatial domain At 404, the method includes providing the low-resolution image frame to the neural network for the faster and accurate inference of the image frame.

The various actions, acts, blocks, steps, or the like in the flow diagram (400) may be performed in the order presented, in a different order, or simultaneously. Further, in various embodiments, some of the actions, acts, blocks, steps, or the like may be omitted, added, modified, skipped, or the like without departing from the scope of the disclosure.

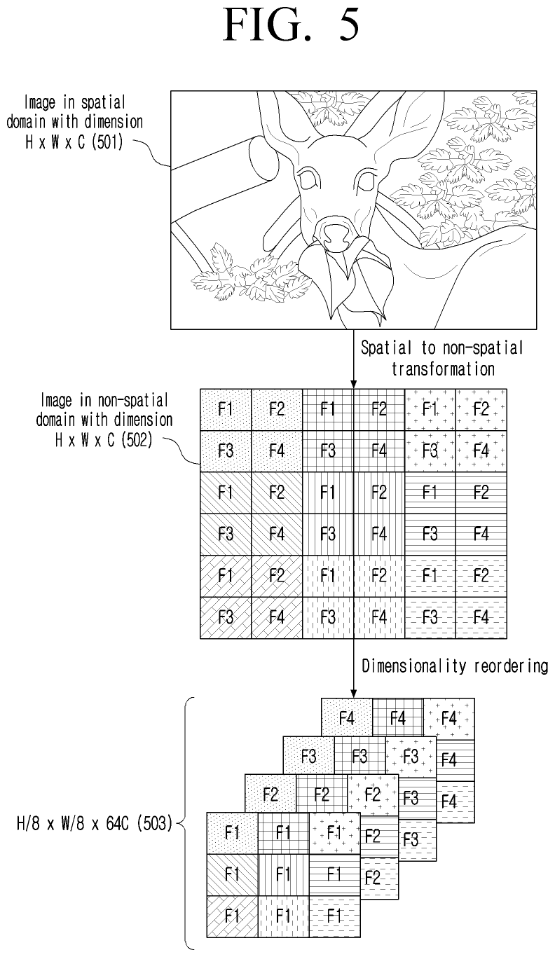

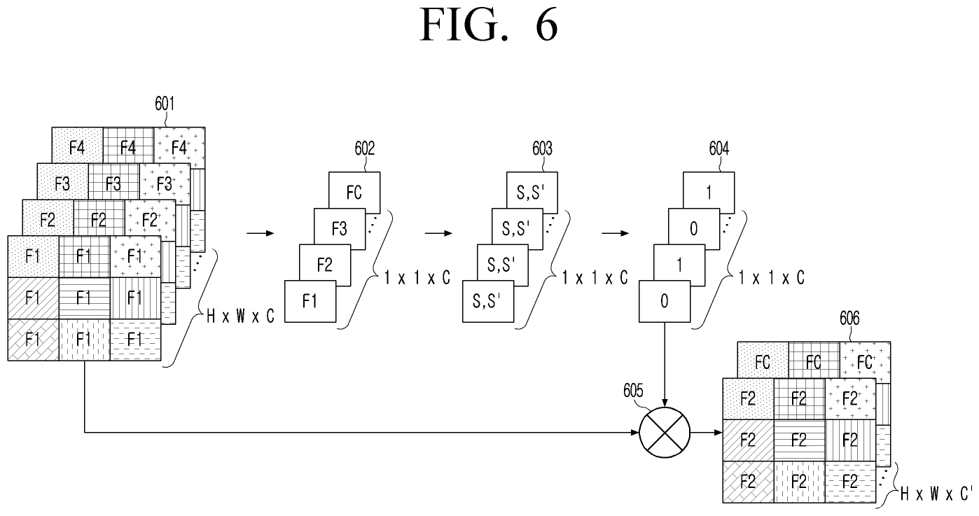

FIGS. 5 and 6 are diagrams illustrating examples of efficiently reducing the dimensions of the image frame, according to various embodiments. As shown in FIG. 5, at 501, the electronic device (100) receives the image in the spatial domain with the dimensions H×W×C. H, W, C represent height, width, and number of channels of the image in the spatial domain respectively. At 502, the electronic device (100) transforms the image to the Y, C, B domain or the H, S, V domain or the Y, U, V domain, and applies a non-spatial transformation in the image in the Y, C, B domain or the H, S, V domain or the Y, U, V domain. The image in the non-spatial domain includes the components and the frequency (e.g. F1, F2, F3, F4) of each component. At 503 the electronic device (100) reorders the dimensionality of the image in the non-spatial domain and groups components of the transformed image with same frequency into one channel by preserving spatial position information of each component. For example, the electronic device (100) applies an 8×8 DCT over the image in the spatial domain to generate the image in the non-spatial domain with dimensionality of H/8×W/8×64C. Thus, the dimensionality of the image in the non-spatial domain contains a smaller height, width, and larger number of channels. Reducing the height and the width, and increasing a depth (e.g., number of channels) of an input image of a hardware accelerator such as GPU, DSP, NPU, etc. makes the hardware accelerator execution friendly.

As shown in FIG. 6, at 601, the electronic device (100) receives the image in the non-spatial domain with dimensionality of H×W×C. The H, W, C represent height, width, and number of channels of the image in the non-spatial domain respectively. At 602, the electronic device (100) performs the depth-wise convolution and the average pool on each channel of the image in the non-spatial domain and creates a first tensor of dimension 1×1×C. The height and the width of the first tensor are 1 and the number of channels of the first tensor is C. At 603, the electronic device (100) adds the two trainable parameters S and S′ with each component of the first tensor across all the channels of the first tensor. Further, the electronic device (100) determines the values of the two trainable parameters S and S′ using the AI engine (150). At 604, the electronic device (100) assigs the binary value 0 or 1 to each component of the first tensor based on the learned values of the two trainable parameters S and S′ using Bernoulli distribution. At 605, the electronic device (100) determines the elementwise multiplication/product between each channel in the non-spatial domain and its respective binary value (e.g., 0 or 1) obtained at 604.

The channel in the non-spatial domain multiplied by 0 will trim or ignore. The channel in the non-spatial domain multiplied with 1 will retain. At 606, the electronic device (100) combines the channel in the non-spatial domain that are retained to form a second tensor (e.g., low-resolution image frame) of dimension H×W×C′. The H, W, C′ represents height, width, and a number of channels of the second tensor respectively. C′ will be always very less than C. Since only C′ number of channels are transmitted to next stage of the DNN or the neural network, the disclosed method results in better performance and memory data transfers. Also, since the C′ number of channels encapsulates most relevant information, the disclosed method also results in increased accuracy against traditional spatial method.

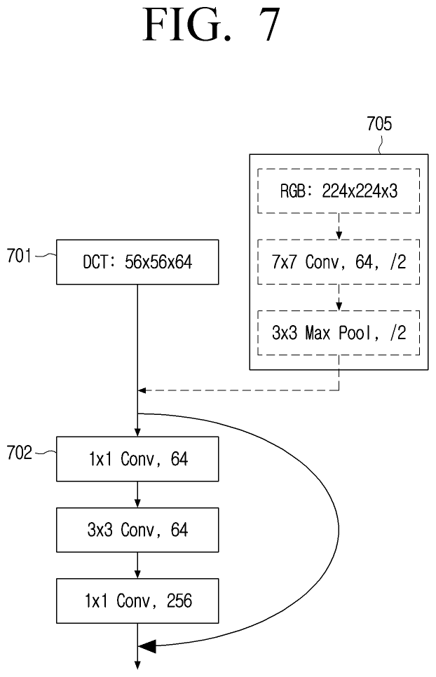

FIG. 7 is a diagram illustrating an example scenario of embedding the generic stub layer at the input of the neural network, according to various embodiments. The electronic device (100) analyses the layers of the neural network to which the second tensor needs to be fed. Further, the electronic device (100) bypasses or omits unnecessary layers of the neural network that are relevant only for the spatial domain and thereby allowing the second tensor in the non-spatial domain to be fed easily to remaining layers of the existing neural networks/DNNs without changing them.

Consider, an example of an existing neural network with layers (701-704). The layer (701) of the neural network is useful for processing the image frame in the spatial domain, and may not be useful only for processing the second tensor. The generic stub layer (705) bypasses the layer (701) of the neural network, and embeds it to the second layer (702) of the neural network for compatibility of the neural network in receiving the second tensor (e.g., low-resolution image frame) of dimension H×W×C′. The generic stub layer (705) receives the second tensor (e.g., low-resolution image frame) of dimension H×W×C′, and further provides the second tensor after processing using layers of the generic stub layer (705) to the second layer (702) of the neural network. With help of the generic stub layer (705), the disclosed method is easily adaptable to the existing neural networks/DNNs without modifying a network architecture or retraining the layers of the existing neural networks/DNNs.

The various example embodiments disclosed herein can be implemented using at least one hardware device and performing network management functions to control the elements.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method for efficiently reducing dimensions of an image frame by an electronic device, comprising:
receiving, by the electronic device, the image frame;
transforming, by the electronic device, the image frame from a spatial domain comprising a first plurality of channels to a non-spatial domain comprising a second plurality of channels, wherein a number of the second plurality of channels is greater than a number of the first plurality of channels;
removing, by the electronic device, at least one channel comprising irrelevant information from among the second plurality of channels using an Artificial Intelligence (AI) engine to generate a low-resolution image frame in the non-spatial domain; and
providing, by the electronic device (100), the low-resolution image frame to a neural network for an inference of the image frame.

2. The method as claimed in claim 1, wherein the transforming, by the electronic device, the image frame from the spatial domain to the non-spatial domain comprises performing, by the electronic device, a Discrete Cosine Transformation (DCT) or a Fourier transformation on the image frame.

3. The method as claimed in claim 1, wherein a generic stub layer is embedded at an input of the neural network for compatibility of the neural network in receiving the low-resolution image frame, wherein the generic stub layer bypasses input layers of the neural network that are relevant for the image frame in the spatial domain.

4. The method as claimed in claim 1, wherein the non-spatial domain comprises a Luminance, Red difference, Blue difference (Y, C, B) domain, a Hue, Saturation, Value (H, S, V) domain, and a Luminance, Chrominance (YUV) domain.

5. The method as claimed in claim 1, wherein transforming, by the electronic device, the image frame from the spatial domain comprising the first plurality of channels to the non-spatial domain comprising the second plurality of channels, wherein the number of the second plurality of channels is greater than the number of the first plurality of channels, comprises:
transforming, by the electronic device, the image frame from the spatial domain to the non-spatial domain with the first plurality of channels; and
grouping, by the electronic device, components of the transformed image frame with a same frequency into a channel of the second plurality of channels by preserving spatial position information of each component.

6. The method as claimed in claim 1, wherein removing, by the electronic device, the at least one channel comprising the irrelevant information from among the second plurality of channels using the AI engine to generate the low-resolution image frame in the non-spatial domain, comprises:
generating, by the electronic device, a tensor by performing a depth-wise convolution and average pool on each channel of the second plurality of channels;
adding, by the electronic device, two trainable parameters with each component of the tensor;
determining, by the electronic device, values of the two trainable parameters using the AI engine;
determining, by the electronic device, a binary value of each component of the tensor based on the values of the two trainable parameters;
performing, by the electronic device, an elementwise product between the second plurality of channels and the binary value of the components of the tensor;
filtering, by the electronic device, at least one channel without a zero value among the second plurality of channels upon performing the elementwise product; and
generating, by the electronic device, the low-resolution image frame in the non-spatial domain using the at least one filtered channel.

7. An electronic device configured to efficiently reduce dimensions of an image frame, comprising:
a memory;
a processor; and
an image frame inferencing engine comprising processing circuitry, operably coupled to the memory and memory, and configured to:
receive the image frame,
transform the image frame from a spatial domain comprising a first plurality of channels to a non-spatial domain comprising a second plurality of channels, wherein a number of the second plurality of channels is greater than a number of the first plurality of channels,
remove at least one channel comprising irrelevant information from among the second plurality of channels using an Artificial Intelligence (AI) engine to generate a low-resolution image frame in the non-spatial domain, and
provide the low-resolution image frame to a neural network for an inference of the image frame.

8. The electronic device as claimed in claim 7, wherein the image frame inferencing engine is further configured to perform a Discrete Cosine Transformation (DCT) or a Fourier transformation on the image frame for transforming the image frame from the spatial domain to the non-spatial domain.

9. The electronic device as claimed in claim 7, further comprising a generic stub layer embedded at an input of the neural network for compatibility of the neural network in receiving the low-resolution image frame, wherein the generic stub layer is configured to bypass input layers of the neural network that are relevant for the image frame in the spatial domain.

10. The electronic device as claimed in claim 7, wherein the non-spatial domain comprises a Luminance, Red difference, Blue difference (Y, C, B) domain, a Hue, Saturation, Value (H, S, V) domain, and a Luminance, Chrominance (YUV) domain

11. The electronic device as claimed in claim 7, wherein the image frame inferencing engine is further configured to:
transform the image frame from the spatial domain to the non-spatial domain with the first plurality of channels; and
group components of the transformed image frame having a same frequency into a channel of the second plurality of channels by preserving spatial position information of each component.

12. The electronic device as claimed in claim 7, wherein the image frame inferencing engine is further configured to:
generate a tensor by performing a depth-wise convolution and average pool on each channel of the second plurality of channels;
add two trainable parameters with each component of the tensor;
determine values of the two trainable parameters using the AI engine;
determine a binary value of each component of the tensor based on the values of the two trainable parameters;
perform an elementwise product between the second plurality of channels and the binary value of the components of the tensor;
filter at least one channel without zero value among the second plurality of channels upon performing the elementwise product; and
generate the low-resolution image frame in the non-spatial domain using the at least one filtered channel.
